(19) United States
(12) Patent Application Publication
(10) Pub. No.: US 2025/0335965 A1
(43) Pub. Date: Oct. 30, 2025

(54) SYSTEM AND METHOD FOR DETERMINING AND PRESENTING CROSS-MAKE AND CROSS-SEGMENT VEHICLE RECOMMENDATIONS

(71) Applicant: TrueCar, Inc., Santa Monica, CA (US)

(72) Inventors: Stanley Cai, Ridgefield, CT (US); Anil Gupta, West Hills, CA (US); Mahesh Ogale, Round Rock, TX (US)

(21) Appl. No.: 18/810,249

(22) Filed: Aug. 20, 2024

Related U.S. Application Data
(60) Provisional application No. 63/640,500, filed on Apr. 30, 2024.

(51) Int. Cl. G06Q 30/0601

(52) U.S. Cl. CPC G06Q 30/0631

(57) ABSTRACT

Systems and methods herein provide for cross-make and cross-model vehicle recommendations. A query is provided that represents a selected vehicle. Features of a candidate vehicle, as determined by engineered features of the machine learning model, are evaluated with respect to selected vehicle features. The candidate vehicle recommendation decision is determined by the machine learning model based on a binary classification of the features of candidate vehicle.

### CROSS-REFERENCE TO RELATED APPLICATION(S)

This application is a conversion of and claims a benefit of priority under 35 U.S.C. § 119(e) from U.S. Provisional Application No. 63/640,500, filed Apr. 30, 2024, entitled “SYSTEM AND METHOD FOR DETERMINING AND PRESENTING CROSS-MAKE AND CROSS-SEGMENT VEHICLE RECOMMENDATIONS,” which is fully incorporated by reference herein in its entirety, including the appendix.

### COPYRIGHT NOTICE

A portion of the disclosure of this patent document contains material that is subject to copyright protection. The copyright owner has no objection to facsimile reproduction of the patent document or the patent disclosure as it appears in the Patent and Trademark Office patent file or records, but otherwise reserves all copyright rights thereto.

### TECHNICAL FIELD

The present disclosure relates to determining vehicle recommendations using artificial intelligence. More particularly, the present disclosure relates to the use of networked computer systems in recognizing a selection of a vehicle make and model and determining cross-segment recommendations corresponding to models from (e.g., different) vehicle makes using artificial intelligence. Even more specifically, the present disclosure relates to improving the relevance of vehicle recommendations by using an artificial intelligence model in a computer network to populate a set of recommended vehicles for a plurality of segments based on a single selection of a vehicle make and model.

### BACKGROUND OF THE RELATED ART

Initially, consumers looked to e-commerce platforms for purchasing familiar consumer goods and basic home services. Today, a growing number of goods and services are being purchased online, including more expensive items, as consumers recognize the convenience, security and efficiency of an online transaction. Durable goods purchased online now include new and used vehicles. Vehicle purchasing online represents an e-commerce segment that consumers are increasingly using to simplify the vehicle purchasing process.

Due in part to a vehicle being an expensive and infrequent purchase, an e-commerce platform facilitating vehicle purchasing likely has no history regarding a consumer's previous vehicle purchases. If previous purchase history is available, it may not be particularly helpful to a prospective purchaser's current vehicle tastes or needs. In the vehicle industry, this technical challenge is referred to as the “cold start” problem.

When shopping for a vehicle through an online platform, a consumer may initially select a single make and model. For example, a consumer may initially select a Honda Pilot as a car of interest. Modern car e-commerce sites may employ hard-coded business logic to recommend dozens of other Honda Pilot sub-models to the consumer. This approach limits consumer choice. Offering additional sub-models of a selected make and model does not provide a consumer with the best possible information to make an informed purchasing decision.

Further, using hard-coded business logic to recommend other makes and models of vehicles does not provide scalability that a modern platform requires to assist an appropriate number of unique vehicle shoppers.

Thus, there is a need for presenting relevant, diverse vehicle recommendations that supplement an initial vehicle selection of a prospective purchaser.

### SUMMARY

E-commerce platforms are useful tools for purchasing products or services, especially in the context of vehicle sales or purchases. Providing recommendations of vehicles to a prospective purchaser presents unique challenges to a platform, because the platform likely has limited, stale or no data regarding a previous vehicle purchase by the prospective purchaser.

The use of hard-coded logic to provide recommendations suffers from difficulty with respect to scalability and accuracy. Thus, hard-coded logic is not suitable for a platform to help a shopper find the best possible vehicle matches for an individual.

A machine learning approach is disclosed herein that effectively recommends a diverse set of makes and models of vehicles, regardless of the span, number of purchases, or even the existence of a consumer's purchase history. Specifically, the diverse set of vehicle recommendations comprises vehicle recommendations from other car makers that are different entities than the car maker(s) and model that the user has selected. This allows for a user to be apprised of a number of different, yet relevant car makes and models without requiring the user to peruse a vast catalog of vehicles. The machine learning approach provides a consumer with a substantial number of choices so that the consumer can make a value-driven purchase, while enjoying the convenience of an e-commerce platform in their vehicle shopping experience.

Specifically, what is desired is the ability of a vehicle e-commerce platform to identify cross-make and cross-model recommendations with limited or no previous purchase history data of the prospective buyer.

Accordingly, attention is thus directed to the systems presented herein, which provides a trained machine-learning model for providing cross-make and cross-segment vehicle recommendations. Even more specifically, a machine learning model is trained using one or more features engineered from data sources.

In certain embodiments, a vehicle data system may include a machine learning model trained to provide cross-make cross-model recommendations based on limited or the absence of historical data relating to a user preference.

In one embodiment, the machine learning machine learning training problem may not utilize standard ranking problem but instead utilize binary classification. Binary classification probabilities can then be used to order car recommendations to users, enabling the use of higher-performing standard machine learning models such as Random Forest which are strong at capturing feature interactions.

In some embodiments, to serve recommendation to users in real-time a web service or the like may be employed to retrieve (e.g., inventory) data from a data store (e.g., ElasticSearch) on a basis such as user preferences and run a (e.g., trained) machine learning model using an in-memory instance (e.g., Apache Spark) in real-time.

Embodiments thus provide a variety of technological advantages, including the ability to efficiently recommend vehicles other than a make and model that is initially selected, while maintaining an intention of the initial selection.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of one embodiment of a topology of a computer network including a vehicle data system for providing cross-make cross-model vehicle recommendations.

FIG. 2 depicts one embodiment of a machine learning model of the vehicle data system.

FIG. 3 depicts a method of recommending a cross-make cross-model vehicle in accordance with one embodiment of the subject application.

FIG. 4 is a block diagram depicting one embodiment for training a machine-learning model in accordance with one embodiment of the subject application.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a HD), hardware circuitry or the like, or any combination.

As discussed above, there are a number of unmet desires when it comes to systems and methods of targeting vehicle recommendations from different makes and models other than the make and model selected by a user. Specifically, what is desired is an ability of vehicle data system providers to provide a scalable system to seamlessly provide cross-segment recommendations for users with unique vehicle selections.

To that end, among others, attention is thus directed to the systems presented herein, which provide for the determination of recommendations for users of a vehicle data system to ultimately purchase a vehicle, where the initial selection of a make and model was provided by a user and a plurality of cross-segment recommendations is provided by an artificial intelligence model.

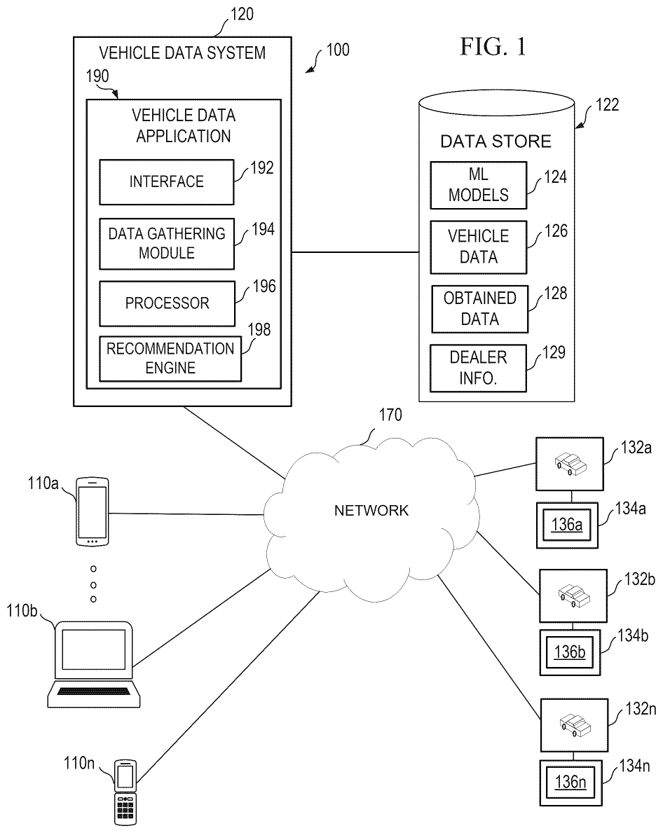

Embodiments of the systems and methods of the present invention may be better explained with reference to FIG. 1, which depicts one embodiment of a topology which may be used to implement embodiments of the systems and methods of the present invention.

Topology 100 comprises a set of entities including vehicle data system 120 (also referred to herein as the TrueCar system) which is coupled through network 170 to computing devices 110 (e.g. computer systems, personal data assistants, kiosks, laptop computers, tablet devices, mobile telephones, smart phones, etc.), and one or more computing devices at inventory companies, original equipment manufacturers (OEM), and one or more associated point of sale locations, in this embodiment, dealer management systems 134 in car dealers 132. Network 170 may be for example, a wireless or wireline communication network such as the Internet or wide area network (WAN), publicly switched telephone network (PSTN) or any other type of electronic or non-electronic communication link such as mail, courier services or the like.

Vehicle data system 120 may comprise one or more computer systems with central processing units executing instructions embodied on one or more computer readable media where the instructions are configured to perform at least some of the functionality associated with embodiments of the present invention. These applications may include a vehicle data application 190 comprising one or more applications (instructions embodied on a computer readable media) configured to implement an interface 192, data gathering module 194, processor 196, and recommendation engine 198 utilized by the vehicle data system 120. Furthermore, vehicle data system 120 may include data store 122 operable to store machine learning (ML) models 124 and vehicle data 126. Machine learning (ML) models 124 may comprise one or more supervised machine-learning models for providing cross-make cross-model recommendations, or any other type of data associated with embodiments of the present invention or determined during the implementation of those embodiments.

Vehicle data system 120 may provide a wide degree of functionality including utilizing interface 192 configured to, for example, receive and respond to queries from users at computing devices 110. It will be understood that the particular interface 192 utilized in a given context may depend on the functionality being implemented by vehicle data system 120, the type of network 170 utilized to communicate with any particular entity, the type of data to be obtained or presented and the types of systems being utilized at the data store 122. Thus, these interfaces may include, for example web pages, web services, a data entry or database application to which data can be entered or otherwise accessed by a user, or almost any other type of interface which it is desired to utilize in a particular context.

Using these interfaces 192, vehicle data system 120 may obtain data from a computing device 110.

A user of computing device 110 may access the vehicle data system 120 through the provided interfaces 192. In an embodiment, the data gathering module 194 provides display data (e.g. XML data) to the computing device 110. Using the display data, the computing device 110 generates a visual display. Through the visual display, the user can specify a particular make and model of vehicle.

Initially, the vehicle data system 120, using the processor 196, can retrieve a particular set of data from the vehicle data 126 in the data store 122 in response to a general user selection (e.g. keystroke, tap, category selection, make selection). In an embodiment, the particular set of data is a set of vehicle makes and models that correspond to a selected category (e.g. Sedan, SUV, etc.) from a user on the visual display of computing device 110. Using the particular set of data to populate a list of vehicles on the visual display of the computing device 110 assists a user in efficiently selecting a vehicle make and model. The particular set of data is processed using processor 196 and based on the processing, the visual display on computing device 110 is updated to show the list of vehicles. More specifically, in one embodiment interface 192 visually presents the visual display to the user in a highly intuitive manner.

In an embodiment, once the user of computing device 110 has made a selection from the list of vehicles on the visual display, the data gathering module 194 receives the vehicle selection data. In an embodiment, the vehicle selection represents a make and model of a vehicle. Vehicle selection data may comprise additional parameters, such as but not limited to model year, color, specific vehicle options, etc. An example of vehicle selection data is provided in the second row of Table 1.

TABLE 1

| Vehicle Model Year | Make | Model | Sub-model | Color |
|---|---|---|---|---|
| 2024 | Toyota | Camry | SE | Silver |
| . . . | . . . | . . . | . . . | . . . |

The processor 196 of vehicle data application obtains the vehicle selection data from the data gathering module 194. The vehicle selection data is provided to the recommendation engine 198. The recommendation engine 198 analyzes the vehicle selection data and provides recommended vehicle data to the data gathering module 194. The recommended vehicle data comprises at least one recommendation for a vehicle that is a different make and a different model (e.g. cross make cross model) than the vehicle indicated by the vehicle suggestion.

Turning to the various other entities in topology 100, dealer 132 (e.g., dealers 132a, 132b . . . 132n) may be a retail outlet for vehicles. The recommended vehicle data provided by recommendation engine 198 may be based on dealer inventory data of dealer 132. Accordingly, in an embodiment, the recommended vehicle data represents one or more vehicles that are available to purchase from dealer inventory.

In some embodiments, a dealer management system (DMS) 134 (e.g., 134a, 134b . . . 134n) is used inventory, among other data. As many DMS 134 are Active Server Pages (ASP) based, inventory data 136 (e.g., 136a, 136b . . . 136n) may be obtained directly from the DMS 134 with a “key” (for example, an ID and Password with set permissions within the DMS system 134) that enables data to be retrieved from the DMS system 134. Many dealers 132 may also have one or more web sites which may be accessed over network 170. Inventory data 136 may be obtained from the DMS 132 and associated with the respective dealer's information 129 in data store 122. The inventory data 136 from the respective dealers may be aggregated and/or processed, and then stored as obtained data 128. In an embodiment, the recommended vehicle data is based on the obtained data 128.

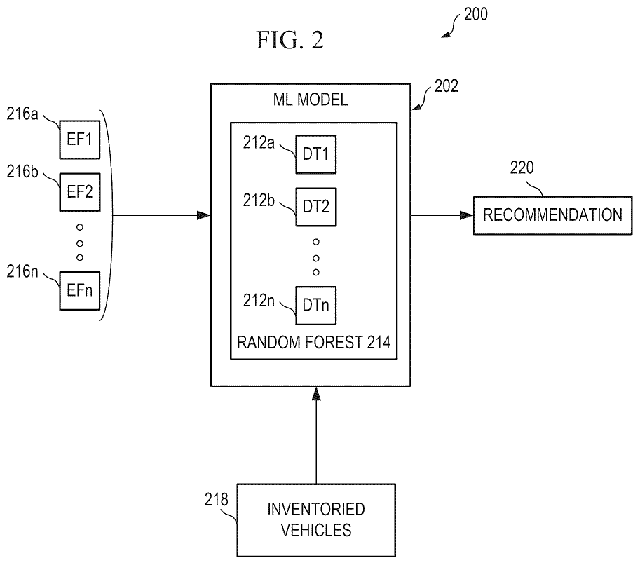

FIG. 2 represents a block diagram 200 of an ML Model 202 that is stored as one or more ML Models 124. In an embodiment, ML Model 202 comprises a random forest 214 comprising a plurality of decision trees 212 (212a, 212b, 212n . . . ) that act as a plurality of sub-models for the ML model 202. Decision trees 212 of random forest 214 assess input data from different perspectives, where each decision tree 212a . . . 212n provides a prediction. In an embodiment, random forest 214 is trained to provide a make and model (e.g. cross-make cross-model) than other than a make and model provided as input data. In an embodiment, the input data provided to the random forest are engineered features engineered features 216 (216a, 216b, 216n . . . ) of a selected vehicle.

In an embodiment, the decision trees 212 of random forest 214 are implemented as binary classification models, and therefore produce binary results for given input data. The decision trees 212 are trained to evaluate the input data comprising the engineered features 216 (216a, 216b, 216n . . . ) of the selected vehicle. The random forest 214 is trained to evaluate input data with respect to vehicle makes and models other than the make/make represented by the input data. Thus, the random forest is trained to determine a candidate vehicle based on the engineered features 216a of the input data. In an embodiment, the candidate vehicle is determined from inventoried vehicles 218 that represent a subset of vehicles in dealer inventory.

As the decision trees 212 of random forest 214 are implemented as binary classification models, the binary results of the respective decision trees 212a . . . 212n are aggregated to make a prediction. In an embodiment, predictions of the decision trees are counted to determine a combined prediction as to whether the candidate vehicle should be provided as a recommendation. In an embodiment, a candidate vehicle with a majority of votes being positive value (e.g. binary “1,” yes, etc.) yields a combined prediction as a positive value is provided a recommendation.

The random forest 214 of ML Model 202 is trained, and can evaluate user vehicle selections, based on engineered features specifically pertinent to an automotive purchaser. In one embodiment, engineered features are integrated with respective decision trees 212a . . . 212n to evaluate variables corresponding to the engineered features. Any combination of the variables, and thus the engineered features, may be evaluated by random forest 214. The collective predictions of the decision trees 212 are evaluated, in an embodiment, to predict whether a candidate vehicle should be recommended.

In an embodiment, decision tree 212a . . . 212n is configured for “styleIDMatch.” Decision tree 210a evaluates whether the vehicle preference of the consumer, as provided by the styleID of the vehicle selection, matches the listingstyleID (the styleID of the candidate recommendation). The output of decision tree 212a . . . 212n, in this embodiment, is a binary value representing a prediction.

In an embodiment, decision tree 212a . . . 212n is configured for “modelcollectionmatch.” Decision tree 210b evaluates whether the vehicle preference model collection ID of the selected vehicle matches the listing model collection ID (the model collection ID of the candidate vehicle). The output of decision tree 212a . . . 212n, in this embodiment, is a binary value representing a prediction.

In an embodiment, decision tree 212a . . . 212n is configured for evaluation of year-agnostic style ID of a vehicle selection with respect to a candidate vehicle. A year-agnostic style ID references a product identifier that remains consistent over multiple different model years. The year agnostic style ID may represent a particular grille design or silhouette of a vehicle. Decision tree 212a . . . 212n evaluates whether the year-agnostic style ID of the vehicle selection of the consumer matches the year-agnostic style ID of the candidate recommendation. The output of decision tree 212a . . . 212n, in this embodiment, is a binary value representing a prediction.

In an embodiment, decision tree 212a . . . 212n is configured for determining a difference between selected vehicle horsepower and candidate recommendation horsepower. The difference is represented as an absolute value, in one embodiment. Decision tree 212a . . . 212n outputs a positive binary value when the absolute value of the difference is between zero and a threshold value.

In an embodiment, decision tree 212a . . . 212n is configured evaluation of vehicle exterior color positive vote by random forest 214 (e.g. binary output of “1”) with respect to exterior color indicates the dominant exterior color of the vehicle candidate is similar to the vehicle selection of the user. In an embodiment, a decision threshold of the random forest determines the change in output of the random forest. For example, if a degree of similarity between exterior colors, as computed by the random forest, exceeds the decision threshold of the random forest, the random forest outputs a positive vote (e.g. binary output of “1”).

In an embodiment, decision tree 212a . . . 212n is configured to provide a value for ‘yearAgnosticStyleIdMatch.’ To provide a prediction for yearAgnosticStyleIdMatch, decision tree 212a . . . 212n evaluates whether the vehicle preference year-agnostic style ID of the vehicle selected by the user matches the listing year-agnostic style ID. The output of decision tree 212a . . . 212n (e.g., the value for yearAgnosticStyleIdMatch) is a binary value. The prediction represented by yearAgnosticStyleIdMatch is calculated by determining whether “userYearAgnosticStyleId” is equal to “listingYearAgnosticStyleId.”

In an embodiment, decision tree 212a . . . 212n is configured to provide a value for ‘exteriorColorSimilarity.’ To provide a prediction for exteriorColorSimilarity, decision tree 212a . . . 212n evaluates whether the exterior color of the vehicle preference of the user is similar to the listing vehicle. The output of decision tree 212a . . . 212n (e.g., the value for exteriorColorSimilarity) is a continuous variable calculated by pulling from a monthly ML team color_similarity_models job.

In an embodiment, decision tree 212a . . . 212n is configured to provide a value for ‘modelIdMatch.’ To provide a prediction for modelIdMatch, decision tree 212a . . . 212n evaluates whether the vehicle identification pass rate (VIPR) model ID of the consumer vehicle preference is identical to the listing vehicle. The output of decision tree 212a . . . 212n (e.g., the value for modelIdMatch) is a binary variable. The prediction represented by modelIdMatch is calculated by determining whether “userModelId” is equal to “listingModelId.”

In an embodiment, decision tree 212a . . . 212n is configured to provide a value for ‘horsepowerDifference.’ To provide a prediction for horsepowerDifference, decision tree 212a . . . 212n evaluates the magnitude of the difference in horsepower between the consumer vehicle preference and the listing vehicle. The output of decision tree 212a . . . 212n (e.g., the value for horsepowerDifference) is a continuous variable calculated by “userHorsepower-listingHorsepower.”

In an embodiment, decision tree 212a . . . 212n is configured to provide a value for ‘listingCpoMileageRestriction.’ To provide a prediction for listingCpoMileageRestriction, decision tree 212a . . . 212n evaluates the certified pre-owned (CPO) mileage restriction. The output of decision tree 212a . . . 212n (e.g., the value for listingCpoMileageRestriction) is pulled directly from one or more vehicle listings.

In an embodiment, decision tree 212a . . . 212n is configured to provide a value for ‘priceRatioUsed.’ To provide a prediction for priceRatioUsed, decision tree 212a . . . 212n evaluates the ratio between the used car list price and the used car fair market price. The output of decision tree 212a . . . 212n (e.g., the value for priceRatioUsed) is for used cars only and is calculated by “listinglistPrice/listingFairPrice.”

In an embodiment, decision tree 212a . . . 212n is configured to provide a value for ‘odometerDifference.’ To provide a prediction for odometerDifference, decision tree 212a . . . 212n evaluates the difference in odometer reading between the consumer vehicle preference and listing vehicle. The output of decision tree 212a . . . 212n (e.g., the value for odometerDifference) is a continuous variable calculated by “listingOdometer-userOdometer.”

In an embodiment, decision tree 212a . . . 212n is configured to provide a value for ‘driveTypeMatch.’ To provide a prediction for driveTypeMatch, decision tree 212a . . . 212n evaluates whether the drive type of the consumer vehicle preference matches the listing vehicle. The output of decision tree 212a . . . 212n (e.g., the value for driveTypeMatch) is a binary variable calculated by determining whether “userDriveTypeName” is equal to “listingDriveType.”

In an embodiment, decision tree 212a . . . 212n is configured to provide a value for ‘userOdometer.’ To provide a prediction for userOdometer, decision tree 212a . . . 212n evaluates the odometer reading of the consumer vehicle preference. The output of decision tree 212a . . . 212n (e.g., the value for userOdometer) is pulled directly from cloud storage and marketplace leads.

In an embodiment, decision tree 212a . . . 212n is configured to provide a value for ‘listingIsDpActive.’ To provide a prediction for listingIsDpActive, decision tree 212a . . . 212n evaluates if “isDpActive” is a listings variable. The output of decision tree 212a . . . 212n (e.g., the value for listingIsDpActive) is pulled directly from one or more vehicle listings.

In an embodiment, decision tree 212a . . . 212n is configured to provide a value for ‘listingOwnerCount.’ To provide a prediction for listingOwnerCount, decision tree 212a . . . 212n evaluates how many prior owners a car has had. The output of decision tree 212a . . . 212n (e.g., the value for listingOwnerCount) is pulled directly from one or more vehicle listings.

In an embodiment, decision tree 212a . . . 212n is configured to provide a value for ‘listingSqrtOdometer.’ To provide a prediction for listingSqrtOdometer, decision tree 212a . . . 212n evaluates an increase in odometer reading from 10 k to 20 k, as such an increase is more impactful than an increase from 150 k to 160 k. The output of decision tree 212a . . . 212n (e.g., the value for listingSqrtOdometer) is a square root function calculated by “sqrt(odometer).”

In an embodiment, decision tree 212a . . . 212n is configured to provide a value for ‘bodyStyleMatch.’ To provide a prediction for bodyStyleMatch, decision tree 212a . . . 212n evaluates whether the consumer vehicle preference body style matches the listing vehicle. The output of decision tree 212a . . . 212n (e.g., the value for bodyStyleMatch) is a binary match variable calculated by determining whether “userBodyStyleName” is equal to “listingBodyStyle.”

In an embodiment, decision tree 212a . . . 212n is configured to provide a value for ‘listingModelId.’ To provide a prediction for listingModelId, decision tree 212a . . . 212n evaluates the VIPR model ID of a listeds vehicle. The output of decision tree 212a . . . 212n (e.g., the value for listingModelId) is pulled directly from one or more vehicle listings.

In an embodiment, decision tree 212a . . . 212n is configured to provide a value for ‘interiorColorSimilarity.’ To provide a prediction for interiorColorSimilarity, decision tree 212a . . . 212n evaluates whether the interior color of the consumer vehicle preference is similar to the listing's vehicle. The output of decision tree 212a . . . 212n (e.g., the value for interiorColorSimilarity) is pulled from a color_similarity_models ML job.

In an embodiment, decision tree 212a . . . 212n is configured to provide a value for ‘listingNewOrUsedId.’ To provide a prediction for listingNewOrUsedId, decision tree 212a . . . 212n evaluates whether the listings vehicle is new or used. The output of decision tree 212a . . . 212n (e.g., the value for listingNewOrUsedId) is a map of {'new': 1, ‘used’: 0}.

In an embodiment, decision tree 212a . . . 212n is configured to provide a value for ‘listingAccidentCount.’ To provide a prediction for listingAccidentCount, decision tree 212a . . . 212n evaluates how many prior accidents a vehicle has had. The output of decision tree 212a . . . 212n (e.g., the value for listingAccidentCount) is pulled directly from one or more vehicle listings.

In an embodiment, decision tree 212a . . . 212n is configured to provide a value for ‘listingStyleId.’ To provide a prediction for listingStyleId, decision tree 212a . . . 212n evaluates the VIPR style ID of a listing vehicle. The output of decision tree 212a . . . 212n (e.g., the value for listingStyleId) is pulled directly from one or more vehicle listings.

In an embodiment, decision tree 212a . . . 212n is configured to provide a value for ‘listingOdometer.’ To provide a prediction for listingOdometer, decision tree 212a . . . 212n evaluates the odometer reading of a listing vehicle. The output of decision tree 212a . . . 212n (e.g., the value for listingOdometer) is pulled directly from one or more vehicle listings.

In an embodiment, decision tree 212a . . . 212n is configured to provide a value for ‘listingModelYear.’ To provide a prediction for listingModelYear, decision tree 212a . . . 212n evaluates the model year of a listing vehicle. The output of decision tree 212a . . . 212n (e.g., the value for listingModelYear) is pulled directly from one or more vehicle listings.

In an embodiment, decision tree 212a . . . 212n is configured to provide a value for ‘listingMakeIdMatch.’ To provide a prediction for listingMakeIdMatch, decision tree 212a . . . 212n evaluates whether the VIPR make ID of a consumer vehicle preference matches the listing vehicle. The output of decision tree 212a . . . 212n (e.g., the value for listingMakeIdMatch) is a binary variable calculated by determining whether “userMakeId” is equal to “listingMakeId.”

In an embodiment, decision tree 212a . . . 212n is configured to provide a value for ‘listingChromeStyleId.’ To provide a prediction for listingChromeStyleId, decision tree 212a . . . 212n evaluates the chrome style ID. The output of decision tree 212a . . . 212n (e.g., the value for listingChromeStyleId) is pulled directly from one or more vehicle listings.

In an embodiment, decision tree 212a . . . 212n is configured to provide a value for ‘modelYearDifference.’ To provide a prediction for modelYearDifference, decision tree 212a . . . 212n evaluates the magnitude of the difference in model year between the consumer vehicle preference and the listing vehicle. The output of decision tree 212a . . . 212n (e.g., the value for modelYearDifference) is calculated by “userModelYear-listingModelYear.”

In an embodiment, decision tree 212a . . . 212n is configured to provide a value for ‘listingCpoModelYearRestriction.’ To provide a prediction for listingCpoModelYearRestriction, decision tree 212a . . . 212n evaluates the CPO model year restriction. The output of decision tree 212a . . . 212n (e.g., the value for listingCpoModelYearRestriction) is pulled directly from one or more vehicle listings.

In an embodiment, decision tree 212a . . . 212n is configured to provide a value for ‘userModelId.’ To provide a prediction for userModelId, decision tree 212a . . . 212n evaluates the vehicle preference VIPR model ID. The output of decision tree 212a . . . 212n (e.g., the value for userModelId) is pulled directly from leads.

In an embodiment, decision tree 212a . . . 212n is configured to provide a value for ‘userStyleId.’ To provide a prediction for userStyleId, decision tree 212a . . . 212n evaluates the vehicle preference VIPR style ID. The output of decision tree 212a . . . 212n (e.g., the value for userStyleId) is pulled directly from leads.

In an embodiment, decision tree 212a . . . 212n is configured to provide a value for ‘userNewOrUsedId.’ To provide a prediction for userNewOrUsedId, decision tree 212a . . . 212n evaluates if the consumer vehicle preference is new or used. The output of decision tree 212a . . . 212n (e.g., the value for userNewOrUsedId) is a map of {‘new’: 1, ‘used’: 0}.

In an embodiment, decision tree 212a . . . 212n is configured to provide a value for ‘listingIsAbpActive.’ To provide a prediction for listingIsAbpActive, decision tree 212a . . . 212n evaluates if the listing vehicle is ABP active. The output of decision tree 212a . . . 212n (e.g., the value for listingIsAbpActive) is pulled directly from one or more vehicle listings.

In an embodiment, decision tree 212a . . . 212n is configured to provide a value for ‘userModelYear.’ To provide a prediction for userModelYear, decision tree 212a . . . 212n evaluates the user model year. The output of decision tree 212a . . . 212n (e.g., the value for userModelYear) is pulled directly from leads.

In an embodiment, decision tree 212a . . . 212n is configured to provide a value for ‘engineConfigurationMatch.’ To provide a prediction for engineConfigurationMatch, decision tree 212a . . . 212n evaluates whether the engine configuration matches between the consumer vehicle preference and listings vehicle. The output of decision tree 212a . . . 212n (e.g., the value for engineConfigurationMatch) is a binary variable calculated by determining whether “userEngineConfiguration” is equal to “listingEngineConfiguration.”

In an embodiment, decision tree 212a . . . 212n is configured to provide a value for ‘priceRatioNewTotalMsrp.’ Decision tree 212a . . . 212n evaluates the ratio between listing total MSRP and consumer vehicle preference total MSRP. The output of decision tree 212a . . . 212n, in this embodiment, is for new cars only and is calculated by “listingTotalMsrp/userTotalMsrp.”

In an embodiment, decision tree 212a . . . 212n is configured to provide a value for ‘priceRatioUserlisting.’ Decision tree 212a . . . 212n evaluates the ratio between list price vs. consumer vehicle preference base MSRP. The output of decision tree 212a . . . 212n, in this embodiment, is calculated by “listlistPrice/userBaseMsrp.”

In an embodiment, decision tree 212a . . . 212n is configured to provide a value for ‘listingMinPrice.’ Decision tree 212a . . . 212n evaluates the minimum market price in listings. The output of decision tree 212a . . . 212n, in this embodiment, is pulled directly from one or more vehicle listings.

In an embodiment, decision tree 212a . . . 212n is configured to provide a value for ‘listingMakeId.’ Decision tree 212a . . . 212n evaluates the VIPR make ID of a listed. The output of decision tree 212a . . . 212n, in this embodiment, is pulled directly from one or more vehicle listings.

In an embodiment, decision tree 212a . . . 212n is configured to provide a value for ‘listingHorsepowerRpm.’ Decision tree 212a . . . 212n evaluates the horsepower RPM of a listed vehicle. The output of decision tree 212a . . . 212n, in this embodiment, is pulled directly from one or more vehicle listings.

In an embodiment, decision tree 212a . . . 212n is configured to provide a value for ‘listingMsrpOrlistPrice.’ Decision tree 212a . . . 212n evaluates the MSRP or list price, where available, of a listed vehicle. The output of decision tree 212a . . . 212n, in this embodiment, is pulled directly from one or more vehicle listings.

In an embodiment, decision tree 212a . . . 212n is configured to provide a value for ‘listingMpgCombined.’ Decision tree 212a . . . 212n evaluates the miles per gallon combined of a listing vehicle. The output of decision tree 212a . . . 212n, in this embodiment, is pulled directly from one or more vehicle listings.

In an embodiment, decision tree 212a . . . 212n is configured to provide a value for ‘listingHorsepower.’ Decision tree 212a . . . 212n evaluates listings horsepower. The output of decision tree 212a . . . 212n, in this embodiment, is pulled directly from one or more vehicle listings.

In an embodiment, decision tree 212a . . . 212n is configured to provide a value for ‘listinglistPrice.’ Decision tree 212a . . . 212n evaluates listings list price. The output of decision tree 212a . . . 212n, in this embodiment, is pulled directly from one or more vehicle listings.

In an embodiment, decision tree 212a . . . 212n is configured to provide a value for ‘listingIndependentDealership.’ Decision tree 212a . . . 212n evaluates whether listings dealership is independent or not. The output of decision tree 212a . . . 212n, in this embodiment, is pulled directly from one or more vehicle listings.

In an embodiment, decision tree 212a . . . 212n is configured to provide a value for ‘engineTypeMatch.’ Decision tree 212a . . . 212n evaluates whether the consumer vehicle preference engine type matches the listing vehicle. The output of decision tree 212a . . . 212n, in this embodiment, is a binary variable calculated by determining whether “userEngineType” is equal to “listingEngineType.”

In an embodiment, decision tree 212a . . . 212n is configured to provide a value for ‘listing Torque.’ Decision tree 212a . . . 212n evaluates the torque of a listeds vehicle. The output of decision tree 212a . . . 212n, in this embodiment, is pulled directly from one or more vehicle listings.

In an embodiment, decision tree 212a . . . 212n is configured to provide a value for ‘listingMpgCity.’ Decision tree 212a . . . 212n evaluates the miles per gallon city. The output of decision tree 212a . . . 212n, in this embodiment, is pulled directly from one or more vehicle listings.

In an embodiment, decision tree 212a . . . 212n is configured to provide a value for ‘listingExcellentPrice.’ Decision tree 212a . . . 212n evaluates the excellent price of a listed vehicle. The output of decision tree 212a . . . 212n, in this embodiment, is pulled directly from one or more vehicle listings.

In an embodiment, decision tree 212a . . . 212n is configured to provide a value for ‘listingMpgHighway.’ Decision tree 212a . . . 212n evaluates the miles per gallon highway. The output of decision tree 212a . . . 212n, in this embodiment, is pulled directly from one or more vehicle listings.

In an embodiment, decision tree 212a . . . 212n is configured to provide a value for ‘listingMarketAverage.’ Decision tree 212a . . . 212n evaluates the market average price. The output of decision tree 212a . . . 212n, in this embodiment, is pulled directly from one or more vehicle listings.

In an embodiment, decision tree 212a . . . 212n is configured to provide a value for ‘priceRatioNewTotalDealerWithoutFees.’ Decision tree 212a . . . 212n evaluates the ratio between listings vehicle total dealer without fees vs. lead vehicle TOTAL_MSRP. The output of decision tree 212a . . . 212n, in this embodiment, is for new cars only and is calculated by “listingTotalDealerWithoutFees/userTotalMsrp.”

In an embodiment, the votes of the decision trees 212 are tallied to determine whether to recommend the candidate vehicle. In an embodiment, when a majority of the votes provided by the respective decision trees 212a . . . 212n are a binary positive value (e.g. a majority of features of the candidate vehicle substantially match the selected vehicle), the ML Model 202, implemented as random forests 210, outputs a positive vote (e.g. “1”) for the candidate vehicle, and the candidate vehicle is predicted by the ML Model 202 as being a recommended vehicle, and a recommendation 220 that includes the recommended vehicle is provided to a user.

In an embodiment, ML Model 202 is trained on historical vehicle sales data. User identity may be tracked during the shopping process, as well as selection of vehicle features. A browsing history is correlated to a user identity. Ultimately, if a user purchases the vehicle, a correlation is determined that the selected features are provided by the purchased vehicle.

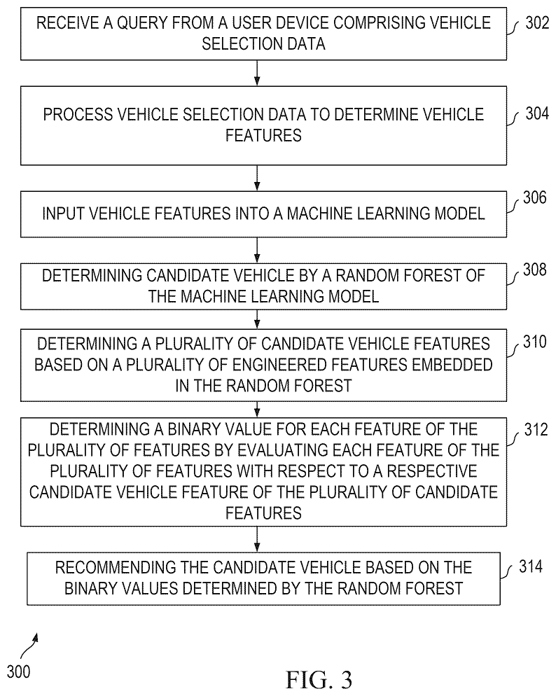

FIG. 3 is a block diagram of one embodiment of a method 300 for providing a cross-make cross-model vehicle recommendation by a vehicle data system.

At 302, vehicle data system receives vehicle selection data from a user (e.g. user device). In an embodiment, the vehicle selection data is in the form of a query (e.g. NoSQL query, Java query, etc.). The vehicle selection data, in an embodiment, specifies the selection on vehicle specifications. These vehicle specifications can include but are not limited to vehicle make, vehicle model, vehicle year, vehicle category (e.g. SUV, sedan, etc.), vehicle color, a range of vehicle miles for a used vehicle, whether the vehicle is new or used, etc. At 304, vehicle data system analyzes the query and processes the query. In an embodiment, the processing comprises parsing the query to determine one or more vehicle features included in the query. In an embodiment, the vehicle features are tokenized, and the tokens are converted into feature vectors that represent the features. At 306, the vehicle features (e.g. feature vectors) are fed into the input layer of the ML model. At 308, a candidate vehicle is determined by the respective random forests of the ML model using available inventory data. At 310, the respective random forests of the ML model are assigned one or more vehicle features to evaluate with respect to a candidate vehicle. At 312, a random forest of the ML model evaluates the one or more feature vectors against the candidate vehicle features to provide a prediction with respect to the candidate vehicle feature. In an embodiment, the prediction is a binary positive or negative value (e.g. “yes” or “no,” “1” or “0”) that represents a vote of a decision tree of the random forest. A vote of the decision tree indicates whether the candidate vehicle feature satisfies a degree of similarity to the vehicle features representing the selected vehicle. At 314, a prediction for recommendation of the candidate vehicle is provided by the random forest. The random forest may tally binary positive votes and binary negative votes of the decision trees; if a majority of the votes are binary positive, the candidate vehicle is recommended to the consumer. Otherwise, if a majority of the votes are binary negative or if there is no majority (e.g. a tie), the candidate vehicle is not provided to the user as a recommended vehicle.

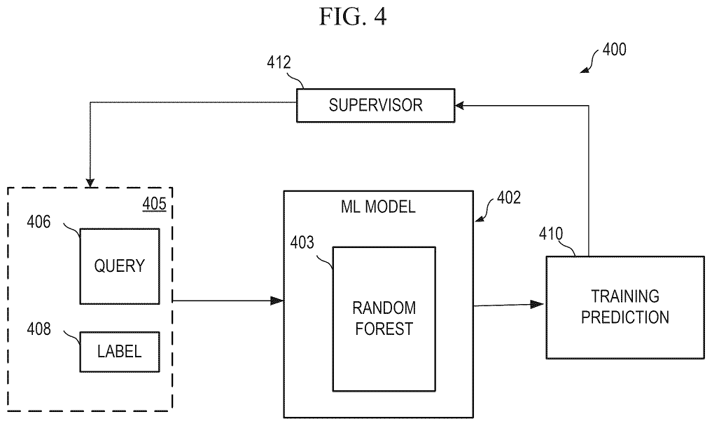

FIG. 4 illustrates an embodiment of a system 400 for training a ML model 402 in accordance with the subject application. In an embodiment, the ML model 402 is a random forest 403 trained using sales history data 405. The sales history data 405 includes attributes of a user query 406 and a corresponding label 408. The attributes of the user query 406 may be data indicating one or more features. The following is a list of features. One or more of the listed features may be included in the sales history data.

The corresponding label 408 is derived from a vehicle purchase based on user query 406. The training prediction 410 of ML model 402 is monitored by supervisor 412 to determine whether the training prediction 410 is consistent with the label 408 associated with user query 406.

Embodiments of a hardware architecture for implementing certain embodiments are described herein. One embodiment can include one or more computers communicatively coupled to a network. As is known to those skilled in the art, the computer can include a central processing unit (CPU), at least one read-only memory (ROM), at least one random access memory (RAM), at least one hard drive (HD), and one or more input/output (I/O) device(s). The I/O devices can include a keyboard, monitor, printer, electronic pointing device (such as a mouse, trackball, stylus, etc.), or the like. In various embodiments, the computer has access to at least one database over the network.

ROM, RAM, and HD are computer memories for storing computer instructions executable (in other which can be directly executed or made executable by, for example, compilation, translation, etc.) by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on computers shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system, comprising:
a vehicle data system comprising:
a data store storing user data for a set of users and a set of historical transaction data comprising data on a set of sales of vehicles, the data for the set of users and the data for the set of historical transactions comprising a set of related data;
a non-transitory computer readable medium, comprising instructions for:
receiving a query from a user, the query indicating a vehicle selection, wherein the vehicle selection indicates a make and a model for a selected vehicle;
processing the query to determine a plurality of features from the vehicle selection;
inputting the plurality of features to a machine learning model, the machine learning model comprising a random forest;
determining a candidate vehicle by the random forest, wherein a candidate vehicle is a different make and different model than the selected vehicle;
determining a plurality of candidate vehicle features based on a plurality of engineered features embedded in the random forest;
determining, by the random forest, a binary value for each feature of the plurality of features, wherein the determining comprises evaluating each feature of the plurality of features with respect to a respective candidate vehicle feature of the plurality of candidate features;
determining a positive count of binary values indicating a binary positive value; and
when the positive count exceeds a threshold count, transmitting the candidate vehicle as a vehicle recommendation to the user.

2. The system of claim 1, wherein the binary value represents a prediction that the candidate vehicle feature corresponds to an engineered feature of the selected vehicle.

3. The system of claim 2, wherein the binary value is determined based on a vote of a decision tree in the random forest.

4. The system of claim 3, wherein the binary value is positive when a candidate vehicle exceeds a threshold value.

5. The system of claim 1, wherein the vehicle recommendation is a cross-make cross-model recommendation.

6. The system of claim 1, wherein the machine learning model is trained on customer sales data for a plurality of vehicles, wherein the customer sales data correlates a purchase to a browsed vehicle.

7. The system of claim 1, wherein the candidate vehicle is determined from a subset of candidate vehicles, wherein the subset of candidate vehicles is determined from an inventory of one or more vehicle dealers.

8. A method, comprising:
receiving a query from a user, the query indicating a vehicle selection, wherein the vehicle selection indicates a make and a model for a selected vehicle;
processing the query to determine a plurality of features from the vehicle selection;
inputting the plurality of features to a machine learning model, the machine learning model comprising a random forest;
determining a candidate vehicle by the random forest, wherein a candidate vehicle is a different make and different model than the selected vehicle;
determining a plurality of candidate vehicle features based on a plurality of engineered features embedded in the random forest;
determining, by the random forest, a binary value for each feature of the plurality of features, wherein the determining comprises evaluating each feature of the plurality of features with respect to a respective candidate vehicle feature of the plurality of candidate features;
determining a positive count of binary values indicating a binary positive value; and
when the positive count exceeds a threshold count, transmitting the candidate vehicle as a vehicle recommendation to the user.

9. The method of claim 8, wherein the binary value represents a prediction that the candidate vehicle feature corresponds to an engineered feature of the selected vehicle.

10. The method of claim 9, wherein the binary value is determined based on a vote of a decision tree in the random forest.

11. The method of claim 10, wherein the binary value is positive when a candidate vehicle exceeds a threshold value.

12. The method of claim 8, wherein the vehicle recommendation is a cross-make cross-model recommendation.

13. The method of claim 8, wherein the machine learning model is trained on customer sales data for a plurality of vehicles, wherein the customer sales data correlates a purchase to a browsed vehicle.

14. The method of claim 8, wherein the candidate vehicle is determined from a subset of candidate vehicles, wherein the subset of candidate vehicles is determined from an inventory of one or more vehicle dealers.

15. A non-transitory computer readable medium, comprising instructions for:
receiving a query from a user, the query indicating a vehicle selection, wherein the vehicle selection indicates a make and a model for a selected vehicle;
processing the query to determine a plurality of features from the vehicle selection;
inputting the plurality of features to a machine learning model, the machine learning model comprising a random forest;
determining a candidate vehicle by the random forest, wherein a candidate vehicle is a different make and different model than the selected vehicle;
determining a plurality of candidate vehicle features based on a plurality of engineered features embedded in the random forest;
determining, by the random forest, a binary value for each feature of the plurality of features, wherein the determining comprises evaluating each feature of the plurality of features with respect to a respective candidate vehicle feature of the plurality of candidate features;
determining a positive count of binary values indicating a binary positive value; and
when the positive count exceeds a threshold count, transmitting the candidate vehicle as a vehicle recommendation to the user.

16. The non-transitory computer readable medium of claim 15, wherein the binary value represents a prediction that the candidate vehicle feature corresponds to an engineered feature of the selected vehicle.

17. The non-transitory computer readable medium of claim 16, wherein the binary value is determined based on a vote of a decision tree in the random forest.

18. The non-transitory computer readable medium of claim 17, wherein the binary value is positive when a candidate vehicle exceeds a threshold value.

19. The non-transitory computer readable medium of claim 15, wherein the vehicle recommendation is a cross-make cross-model recommendation.

20. The non-transitory computer readable medium of claim 15, wherein the machine learning model is trained on customer sales data for a plurality of vehicles, wherein the customer sales data correlates a purchase to a browsed vehicle.
